(19) United States
(12) Patent Application Publication
(10) Pub. No.: US 2025/0282349 A1
(43) Pub. Date: Sep. 11, 2025

(54) VEHICLE CONTROL DEVICE

(71) Applicant: HONDA MOTOR CO., LTD., Tokyo (JP)

(72) Inventor: Sachio KOBAYASHI, Tokyo (JP)

(73) Assignee: HONDA MOTOR CO., LTD., Tokyo (JP)

(21) Appl. No.: 19/058,675

(22) Filed: Feb. 20, 2025

(30) Foreign Application Priority Data
Mar. 11, 2024 (JP) 2024-037316

(51) Int. Cl. B60W 30/12; B60W 10/20; G06V 20/56

(52) U.S. Cl. CPC B60W 30/12; B60W 10/20; G06V 20/588; B60W 2420/403; B60W 2552/30; B60W 2552/53

(57) ABSTRACT

A vehicle control device for controlling a vehicle includes circuitry configured to: recognize a surrounding situation of the vehicle including a first lane, in which the vehicle travels, and a road having the first lane; and set a target traveling line of the vehicle in the first lane based on the recognized surrounding situation, and control steering of the vehicle such that the vehicle travels along the target traveling line. When the road has a second lane adjacent to the first lane, the circuitry is configured to set, as the target traveling line, a line offset to a left side or a right side by a predetermined offset amount from a lane center line of the first lane.

### CROSS-REFERENCE TO RELATED APPLICATIONS

This application is based on and claims priority under 35 USC 119 from Japanese Patent Application No. 2024-037316 filed on Mar. 11, 2024, the contents of which are incorporated herein by reference.

### TECHNICAL FIELD

The present disclosure relates to a vehicle control device that controls a vehicle.

### BACKGROUND

In recent years, attempts have been made to provide access to a sustainable transportation system in consideration of vulnerable traffic participants. As one of the attempts, research and development on driving support technique and automated driving technique of a vehicle such as an automobile have been performed in order to further improve safety and convenience of traffic.

As an example of the driving support technique, Japanese Patent Application Laid-Open Publication No. 2023-063625A below discloses a technique. In the technique, in a case where during execution of lane keeping control, a left limit line extending along a host lane through a position separated from a left target by a predetermined distance in a right direction is set as a left end line, a right limit line extending along the host lane through a position separated from a right target by a predetermined right separation distance in a left direction is set as a right end line, and the left end line and the right end line are set in the left and right order, when a lane center line is not between the left end line and the right end line, a line closer to the lane center line among the left end line and the right end line is set as a target traveling line.

Japanese Patent Application Laid-Open Publication No. 2014-080046A below discloses a technique. In the technique, based on a moving object avoidance trajectory obtained by enlarging a basic avoidance trajectory, which is for a vehicle to travel while avoiding an obstacle, in a traveling direction of the vehicle in accordance with a relative speed between the vehicle and the obstacle, an actuator of the vehicle is controlled to assist traveling of the vehicle.

However, in the related art, an offset amount from the lane center line of the host lane to the target traveling line may vary between a section where the target (for example, another vehicle) is present on the left side or the right side of the host lane in which the host vehicle travels and a section where the target is not present.

By causing the host vehicle to travel along such a target traveling line, the host vehicle may wobble to the left and the right with respect to the lane center line of the host lane, and the driver of the host vehicle may feel a discomfort.

The present disclosure relates to providing a vehicle control device capable of supporting a vehicle to travel along an appropriate target traveling line while preventing the vehicle from wobbling to the left and right with respect to a lane center line of a host lane. Further, it is possible to improve traffic safety and contribute to development of a sustainable transportation system.

### SUMMARY

An aspect of the present disclosure relates to a vehicle control device for controlling a vehicle, in which the vehicle control device comprising circuitry configured to:
recognize a surrounding situation of the vehicle including a first lane, in which the vehicle travels, and a road having the first lane; and
set a target traveling line of the vehicle in the first lane based on the recognized surrounding situation, and control steering of the vehicle such that the vehicle travels along the target traveling line, wherein
when the road has a second lane adjacent to the first lane, the circuitry is configured to set, as the target traveling line, a line offset to a left side or a right side by a predetermined offset amount from a lane center line of the first lane.

According to the present disclosure, it is possible to provide a vehicle control device capable of supporting a host vehicle to travel along an appropriate target traveling line while suppressing the host vehicle from wobbling to the left and right with respect to a lane center line of a host lane.

### BRIEF DESCRIPTION OF DRAWINGS

Exemplary embodiments of the present disclosure will be described in detail based on the following figures, wherein:

FIG. 1 is a block diagram illustrating a schematic configuration of a vehicle including a control device 30 according to an embodiment;

FIG. 2 is a diagram illustrating a first example of vehicle control performed by the control device 30;

FIG. 3 is a diagram illustrating a second example of vehicle control performed by the control device 30;

FIG. 4 is a diagram illustrating a third example of vehicle control performed by the control device 30;

FIG. 5A is a diagram illustrating a fourth example of vehicle control performed by the control device 30;

FIG. 5B is a diagram illustrating a fourth example of vehicle control performed by the control device 30;

FIG. 6 is a flowchart (part 1) illustrating an example of processing executed by the control device 30;

FIG. 7 is a flowchart (part 2) illustrating the example of processing executed by the control device 30;

FIG. 8 is a flowchart (part 3) illustrating the example of processing executed by the control device 30;

FIG. 9A is a diagram (part 1) illustrating a modification of vehicle control performed by the control device 30;

FIG. 9B is a diagram (part 1) illustrating a modification of vehicle control performed by the control device 30;

FIG. 10A is a diagram (part 2) illustrating a modification of vehicle control performed by the control device 30;

FIG. 10B is a diagram (part 2) illustrating a modification of vehicle control performed by the control device 30;

FIG. 11 is a diagram (part 3) illustrating a modification of vehicle control performed by the control device 30; and

FIG. 12 is a diagram (part 4) illustrating a modification of vehicle control performed by the control device 30.

### DESCRIPTION OF EMBODIMENTS

Hereinafter, an embodiment of a vehicle control device according to the present disclosure will be described with reference to the drawings. The following embodiment does not limit the present disclosure, and not all elements described in the following embodiment are essential to the present disclosure. Further, two or more elements described in the following embodiment may be freely combined without departing from the gist of the present disclosure. Hereinafter, the same or similar elements are denoted by the same or similar reference signs, and a description thereof may be omitted or simplified.

### Vehicle

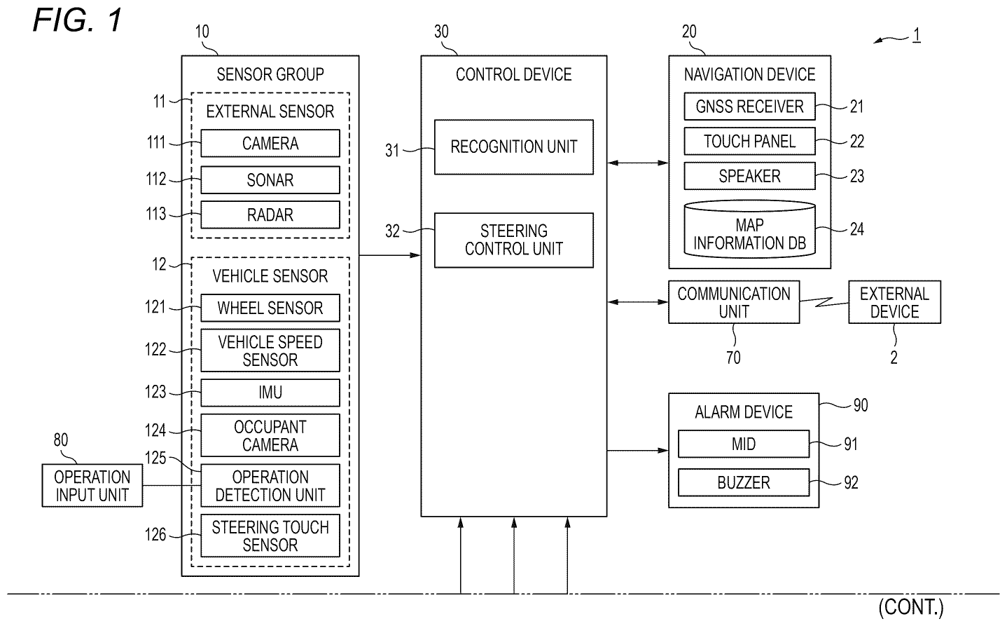

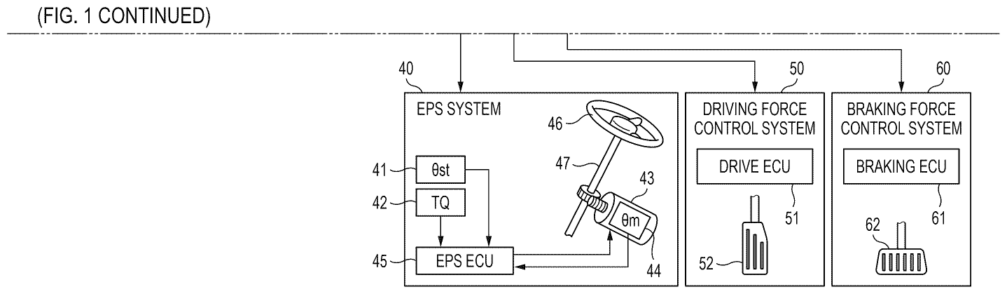

First, a vehicle according to the present embodiment will be described. A vehicle 1 according to the present embodiment illustrated in FIG. 1 is an automobile including a drive source (not illustrated), and wheels (not illustrated) including drive wheels driven by power of the drive source and steered wheels that are steerable. For example, the vehicle 1 may be a four-wheeled automobile having a pair of left and right front wheels and a pair of left and right rear wheels.

The drive source of the vehicle 1 may be an electric motor, an internal combustion engine such as a gasoline engine or a diesel engine, or a combination of an electric motor and an internal combustion engine. The drive source of the vehicle 1 may drive the pair of left and right front wheels, the pair of left and right rear wheels, or four wheels including the pair of left and right front wheels and the pair of left and right rear wheels. The front wheels and the rear wheels may all be steerable steered wheels, or the front wheels or the rear wheels may be steerable steered wheels.

The vehicle 1 includes a sensor group 10, a navigation device 20, the control device 30 that is an example of the vehicle control device of the present disclosure, an electric power steering (EPS) system 40, a driving force control system 50, a braking force control system 60, a communication unit 70, an operation input unit 80, and an alarm device 90.

The sensor group 10 includes an external sensor 11 that acquires information on a periphery of the vehicle 1 (hereinafter also referred to as “peripheral information”), and a vehicle sensor 12 that acquires information on the vehicle 1 (hereinafter also referred to as “vehicle information”). Information (in other words, detection values) acquired by each sensor in the sensor group 10 is output to the control device 30, and is used for control of the vehicle 1 (hereinafter, also referred to as “vehicle control”) performed by the control device 30.

The external sensor 11 includes, for example, a camera 111, a sonar 112, and a radar 113. The camera 111 is a digital camera that images the periphery of the vehicle 1 including the front of the vehicle 1 and outputs image data of the obtained peripheral image to the control device 30. As the camera 111, for example, a digital camera using an imaging element such as a charge-coupled device (CCD) or a complementary metal oxide semiconductor (CMOS) can be employed.

The sonar 112 emits sound waves to the periphery of the vehicle 1 (for example, the front, the rear, and lateral sides of the vehicle 1), and receives reflected sounds from an object present in the periphery of the vehicle 1, thereby detecting a distance to the object, an azimuth of the object, and the like. The radar 113 emits radio waves to the periphery of the vehicle 1 including the front of the vehicle 1, and receives reflected waves from an object present in the periphery of the vehicle 1, thereby detecting a distance to the object, an azimuth of the object, and the like. As the radar 113, for example, a millimeter wave radar can be employed.

The external sensor 11 may include light detection and ranging (LiDAR) instead of or in addition to the sonar 112 and the radar 113. In this case, the LiDAR emits laser light to the periphery of the vehicle 1 including the front of the vehicle 1, and receives reflected light from an object present in the periphery of the vehicle 1, thereby detecting a distance to the object, an azimuth of the object, and the like.

The vehicle sensor 12 includes, for example, a wheel sensor 121, a vehicle speed sensor 122, an inertial measurement unit (IMU) 123, an occupant camera 124, an operation detection unit 125, and a steering touch sensor 126.

The wheel sensor 121 detects a rotation angle of one or more wheels of the wheels of the vehicle 1. For example, the wheel sensor 121 detects rotation angles of a left rear wheel and a right rear wheel. The wheel sensor 121 may be, for example, an angle sensor or a displacement sensor.

The vehicle speed sensor 122 detects a vehicle speed VP that is a travel speed of the vehicle 1 (in other words, a movement speed of a vehicle body). For example, the vehicle speed sensor 122 detects the vehicle speed VP based on a rotation speed of a counter shaft (not illustrated) provided in the vehicle 1.

The inertial measurement unit 123 detects angular velocities of the vehicle 1 in a pitch direction, a roll direction, and a yaw direction, and accelerations of the vehicle 1 in a front-rear direction, a left-right direction, and an upper-lower direction. The vehicle sensor 12 may include, instead of the inertial measurement unit 123, an acceleration sensor that detects an acceleration in a predetermined direction of the vehicle 1 and a gyro sensor that detects an angular velocity in a predetermined direction of the vehicle 1.

The occupant camera 124 is a digital camera that images an interior of the vehicle 1 and outputs image data of the obtained vehicle interior image to the control device 30. For example, the occupant camera 124 may be a so-called “driver monitor camera” that is provided so as to be able to image the head of an occupant from the front (in other words, image the face) who sits on the driver's seat of the vehicle 1 (hereinafter, also referred to as a “driver”). Similarly to the camera 111, a digital camera using an imaging element such as a CCD or a CMOS can be employed as the occupant camera 124.

The operation detection unit 125 detects an operation performed by using the operation input unit 80 that is provided to be operable by the driver. In the present embodiment, the operation input unit 80 may include, for example, an operation button (not illustrated) for receiving an operation of switching between ON (in other words, enabled) and OFF (in other words, disabled) of steering control in which the steering of the vehicle 1 is automatedly controlled such that the vehicle 1 travels along a predetermined target traveling line (described later). In this case, the operation detection unit 125 can detect an operation of turning on/off the steering control.

The steering touch sensor 126 detects whether a steering wheel 46 of the vehicle 1 is appropriately gripped. For example, the steering touch sensor 126 is implemented by a capacitance sensor or the like. In this case, the capacitance sensor is provided at a portion touched by the driver when the steering wheel 46 is appropriately gripped.

The navigation device 20 includes, for example, a global navigation satellite system (GNSS) receiver 21, a touch panel 22, and a speaker 23. The navigation device 20 includes a storage unit (not illustrated) implemented by a flash memory or the like. The storage unit of the navigation device 20 stores a map information database (DB) 24 and the like.

The GNSS receiver 21 specifies a current position of the vehicle 1 (for example, a latitude and a longitude of a location where the vehicle 1 is located) based on a signals received from a GNSS satellite. For example, the navigation device 20 may acquire a detection result of the vehicle sensor 12 (for example, the wheel sensor 121 or the vehicle speed sensor 122) via the control device 30, and specify or complement the current position of the vehicle 1 by an inertial navigation system (INS) in which a detection value of the vehicle sensor 12 is used.

The touch panel 22 is implemented by combining a display device such as a liquid crystal display or an organic light emitting diode (OLED) with a pointing device (for example, a touch pad). The speaker 23 is capable of outputting a sound to the driver.

For example, the navigation device 20 searches for a route leading from the current position of the vehicle 1 to a destination, which is set by the driver using the touch panel 22, by referring to the map information database 24. Then, the navigation device 20 performs route guidance using the touch panel 22 and the speaker 23 based on the searched route. The navigation device 20 may cause the touch panel 22 to perform predetermined display in accordance with an instruction from the control device 30. Further, the navigation device 20 may output, to the control device 30, predetermined information such as information indicating the specified current position of the vehicle 1 and information indicating an operation received via the touch panel 22.

The control device 30 is a computer that includes, for example, a processor configured to perform various calculations, a storage unit having a non-transitory storage medium for storing various types of information, and an input and output unit configured to control input and output of data between an inside and an outside of the control device 30 (none of which is illustrated), and executes overall control of the vehicle 1. For example, the control device 30 is implemented by one electronic control unit (ECU) or by a plurality of ECUs working in cooperation with each other. Since specific examples of control executed by the control device 30 will be described later, the description thereof will be omitted here.

The EPS system 40 includes a steering angle sensor 41, a torque sensor 42, an EPS motor 43, a resolver 44, and an EPS ECU 45.

The steering angle sensor 41 detects a steering angle θst of the steering wheel 46 and outputs information indicating the detected steering angle θst to the EPS ECU 45. The torque sensor 42 detects a steering torque TQ, which is a torque applied to the steering wheel 46 of the vehicle 1, and outputs information indicating the detected steering torque TQ to the EPS ECU 45.

The EPS motor 43 applies a driving force or a reaction force to a steering column 47, which is coupled to the steering wheel 46, in accordance with an instruction from the EPS ECU 45, thereby assisting the driver in operating the steering wheel 46. The resolver 44 detects a rotation angle θm of the EPS motor 43 and outputs information indicating the detected rotation angle θm to the EPS ECU 45.

The EPS ECU 45 is a computer that includes, for example, a processor configured to perform various calculations, a storage unit having a non-transitory storage medium for storing various types of information, and an input and output unit configured to control input and output of data between an inside and an outside of the EPS ECU 45 (none of which is illustrated), and that controls the EPS system 40 (for example, the EPS motor 43), and is implemented by one or more ECUs. For example, the EPS ECU 45 controls the EPS system 40 (for example, the EPS motor 43) based on the steering angle θst detected by the steering angle sensor 41, the steering torque TQ detected by the torque sensor 42, the rotation angle θm detected by the resolver 44, and the like.

The EPS system 40 (for example, the EPS ECU 45) may output information indicating the steering angle θst detected by the steering angle sensor 41, the steering torque

TQ detected by the torque sensor 42, the rotation angle θm detected by the resolver 44, and the like to the control device 30. Further, the EPS system 40 (for example, the EPS ECU 45) may output information indicating a steering speed @ of the steering wheel 46 to the control device 30. In this case, the steering speed @ is obtained by, for example, differentiating the steering angle θst with respect to time.

The driving force control system 50 includes a drive ECU 51, and can control a driving force of the vehicle 1. The drive ECU 51 is a computer that includes, for example, a processor configured to perform various calculations, a storage unit having a non-transitory storage medium for storing various types of information, and an input and output unit configured to control input and output of data between an inside and an outside of the drive ECU 51 (none of which is illustrated), and that controls the driving force control system 50, and is implemented by one or more ECUs. For example, based on an operation on an accelerator pedal 52 provided in the vehicle 1, the drive ECU 51 controls the power output from the drive source of the vehicle 1. The drive ECU 51 can also control the driving force control system 50 (for example, the drive source) according to an instruction from the control device 30.

The braking force control system 60 includes a braking ECU 61 and can control a braking force of the vehicle 1. The braking ECU 61 is a computer that includes, for example, a processor configured to perform various calculations, a storage unit having a non-transitory storage medium for storing various types of information, and an input and output unit configured to control input and output of data between an inside and an outside of the braking ECU 61 (none of which is illustrated), and that controls the braking force control system 60, and is implemented by one or more ECUs. For example, based on an operation on a brake pedal 62 provided in the vehicle 1, the braking ECU 61 controls the braking force of the vehicle 1 by controlling a brake device (not illustrated) provided in the vehicle 1. Here, the brake device includes, for example, a brake caliper, a cylinder that transmits a hydraulic pressure to the brake caliper, and an electric motor that generates a hydraulic pressure in the cylinder. The braking ECU 61 controls the electric motor of the brake device such that a braking force corresponding to the operation on the brake pedal 62 is generated. The braking ECU 61 can also control the braking force control system 60 (for example, the brake device) according to an instruction from the control device 30.

The communication unit 70 is a communication interface that communicates with an external device 2 according to the control of the control device 30. That is, the control device 30 may communicate with the external device 2 via the communication unit 70. Examples of the external device 2 may include a terminal device (for example, a smartphone) of the driver and a server device managed by a manufacturer of the vehicle 1. For example, a mobile communication network such as a cellular line, Wi-Fi (registered trademark), or Bluetooth (registered trademark) can be adopted for the communication between the vehicle 1 and the external device 2.

The alarm device 90 is a device that alarms the driver according to the control of the control device 30. The alarm device 90 includes, for example, a multi-information display (MID) 91 and a buzzer 92. The MID 91 is implemented by, for example, a display device such as a liquid crystal display or an OLED, and is provided at a position (for example, in a meter panel of the vehicle 1) that the driver can visually recognize. For example, when the vehicle 1 is likely to depart from a lane in which the vehicle 1 is traveling (hereinafter also referred to as a “host lane”), the MID 91 may display an alarm image, which indicates that the vehicle 1 is likely to depart from the host lane, according to the control of the control device 30.

The buzzer 92 is capable of outputting a predetermined alarm sound. For example, when the vehicle 1 is likely to depart from the host lane, the buzzer 92 may output a predetermined alarm sound according to the control of the control device 30. One of the buzzer 92 and the speaker 23 may be provided to serve both roles thereof.

### Control Device

Next, the control device 30 will be described in more details. The control device 30 includes, for example, a recognition unit 31 and a steering control unit 32 as functional units implemented by the processor executing a program stored in the storage unit of the control device 30.

The recognition unit 31 recognizes a surrounding situation of the vehicle 1. For example, the recognition unit 31 performs sensor fusion processing on a detection result obtained by a part or all of the camera 111, the sonar 112, and the radar 113 in the external sensor 11, and recognizes the surrounding situation of the vehicle 1 based on a processing result.

More specifically, the recognition unit 31 recognizes a position, a type, a speed, an acceleration, and the like of an object present around the vehicle 1. At this time, the recognition unit 31 recognizes the position of the object as a position on absolute coordinates in which a representative point (for example, the center of gravity and a center of a drive shaft) of the vehicle 1 is set as an origin. Accordingly, a relative position between the vehicle 1 and the object present around the vehicle 1 can be recognized. On the absolute coordinates described above, the position of the object may be represented by using a representative point such as a center of gravity or a corner of the object, or may be represented as a region.

The recognition unit 31 can recognize a surrounding situation including an obstacle present around the vehicle 1, for example. Here, examples of the obstacle may include another traffic participant (for example, another vehicle or a pedestrian) present around the vehicle 1, and a fallen object on a road.

The recognition unit 31 can also recognize the surrounding situation including a shape of the host lane in which the vehicle 1 travels. For example, the recognition unit 31 can recognize the shape of the host lane based on a traveling lane boundary recognized from a peripheral image or the like captured by the camera 111. Here, examples of the traveling lane boundary may include a division line, a road shoulder, a curb, a separation zone, and a guard rail that define a lane.

Further, the recognition unit 31 can also recognize the position of the vehicle 1 with respect to the host lane (for example, a distance from the vehicle 1 to the traveling lane boundary of the host lane, a time required until the vehicle 1 reaches the traveling lane boundary of the host lane). The recognition unit 31 may also recognize a surrounding situation including other road events such as a stop line, a traffic light, a road sign, and a toll gate of a toll road.

The recognition unit 31 can also recognize a road having the host lane (in other words, a road on which the vehicle 1 travels). The “road” in the present specification may include another lane same as the host lane in the traveling direction, and does not include an oncoming lane opposite to the host lane in the traveling direction. That is, in the present specification, a road having the host lane and a road having an oncoming lane of the host lane are handled as different roads.

The recognition unit 31 can also recognize, for example, the number of lanes of the road having the host lane and a width of the host lane. Further, the recognition unit 31 can also recognize, for example, a length of an entry-allowing area in a width direction (hereinafter, also referred to as a “left entry-allowing area width”) that is present adjacently to the host lane on the left side (in other words, one side in the width direction of the host lane), and a length of an entry-allowing area in the width direction (hereinafter, also referred to as a “right entry-allowing area width”) that is present adjacently to the host lane on the right side (in other words, the other side in the width direction of the host lane). Here, the entry-allowing area is an area that the vehicle 1 can physically enter and is, for example, a road shoulder. The recognition unit 31 may recognize an area between a traveling lane boundary of the host lane and a predetermined structure (for example, a guard rail, a separation band, or another lane including an oncoming lane) as the entry-allowing area.

The steering control unit 32 sets a target traveling line of the vehicle 1 in the host lane based on the surrounding situation recognized by the recognition unit 31, and controls the steering of the vehicle 1 such that the vehicle 1 travels along the target traveling line. Such steering control is also referred to as a lane keep assist system (LKAS). For example, the steering control unit 32 executes the steering control based on a fact that an operation of turning on the steering control is detected by the operation detection unit 125. Since a detailed control procedure for implementing such steering control is well known, the description thereof is omitted here.

In the present embodiment, when the road having the host lane in which the vehicle 1 under the steering control travels further has another lane, the steering control unit 32 is able to set, as the target traveling line, a line offset to the left side or right side by a predetermined offset amount from a lane center line of the host lane. For example, when the road having the host lane has another lane adjacent to the host lane, the steering control unit 32 may set, as the target traveling line, a line offset to the left side or right side by a predetermined offset amount from the lane center line of the host lane. The offset amount from the lane center line is determined in advance by, for example, the manufacturer of the vehicle 1. The driver of the vehicle 1 may set a desired offset amount.

As described, when the road having the host lane has another lane, the target traveling line is offset in advance from the lane center line of the host lane to the left side or right side, whereby the vehicle 1 can travel along the target traveling line offset in advance regardless of the presence or absence of a target in the other lane (for example, another vehicle traveling in the other lane). Accordingly, the vehicle 1 can travel with a certain distance from a target present in the other lane, and the vehicle 1 can be prevented from wobbling in the left-right direction with respect to the lane center line of the host lane, as compared with a case where the target traveling line is offset from the lane center line only in a section where a target is present in the other lane. Accordingly, the vehicle 1 can travel along an appropriate target traveling line while being prevented from wobbling in the left-right direction with respect to the lane center line of the host lane. In addition, it is possible to improve traffic safety and contribute to development of a sustainable transportation system.

### Example of Vehicle Control

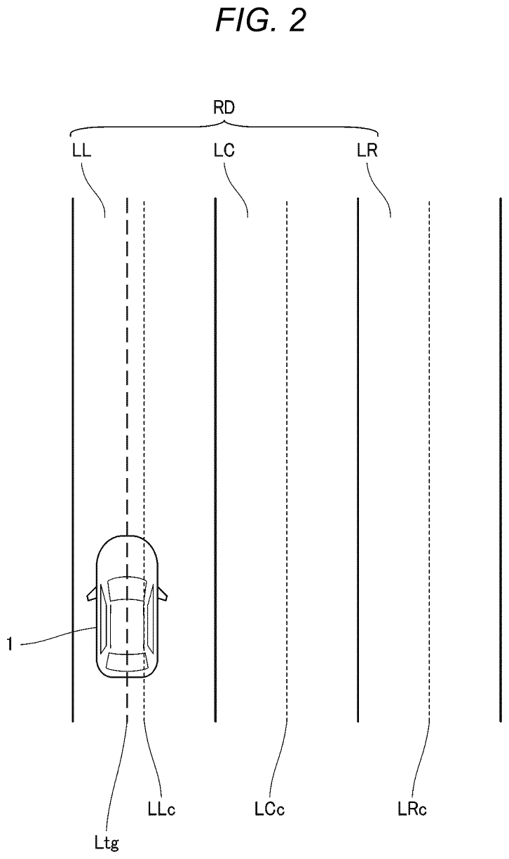

Next, an example of control of the vehicle 1 performed by the control device 30 will be described with reference to FIGS. 2 to 5B. In examples illustrated in FIGS. 2 to 5B, a road RD on which the vehicle 1 travels is a three-lane road having a left lane LL, a center lane LC, and a right lane LR, and in the drawings, a direction from a lower side toward an upper side is defined as the traveling direction.

In the example illustrated in FIG. 2, the vehicle 1 travels in the left lane LL located at the leftmost side among the lanes of the road RD. In other words, in the example illustrated in FIG. 2, the left lane LL is the host lane in which the vehicle 1 travels. The center lane LC that is another lane is present on the right side of the left lane LL that is the host lane. In such a case, the driver of the vehicle 1 traveling in the left lane LL often desires to drive the vehicle 1 at a certain distance from another vehicle traveling in the center lane LC.

Therefore, when the vehicle 1 travels in the left lane LL, the control device 30 (for example, the steering control unit 32) sets, as a target traveling line Ltg, a line offset to the left side by a predetermined offset amount from a lane center line LLc of the left lane LL that is the host lane, for example. Accordingly, the vehicle 1 can travel along an appropriate target traveling line Ltg that matches the driver's sense of wanting to leave a certain distance from the center lane LC present on the right side of the left lane LL that is the host lane.

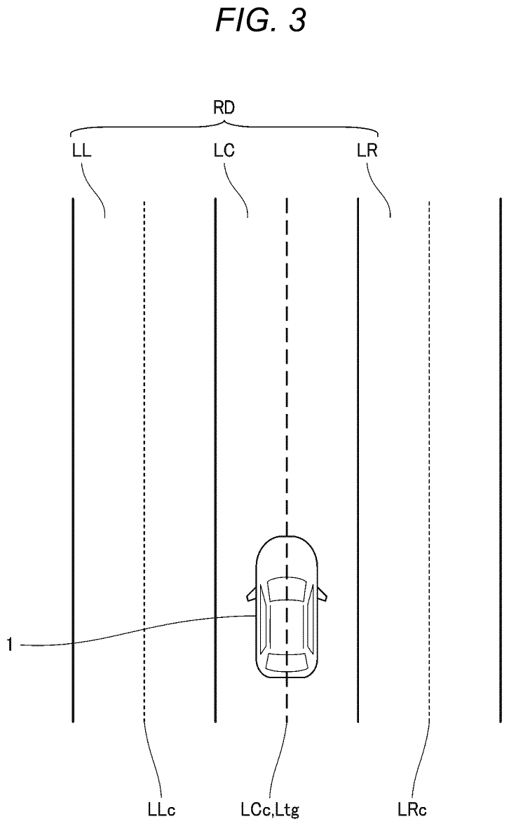

In the example illustrated in FIG. 3, the vehicle 1 travels in the center lane LC that is a lane provided at the center of the road RD. In other words, in the example illustrated in FIG. 3, the center lane LC is the host lane in which the vehicle 1 travels. On the left side of the center lane LC that is the host lane, the left lane LL that is another lane is present, and on the right side of the center lane LC, the right lane LR that is another lane is present. In such a case, the driver of the vehicle 1 traveling in the center lane LC often desires to drive the vehicle 1 near a lane center line LCc of the center lane LC in order to leave a certain distance from each of another vehicle traveling in the left lane LL and another vehicle traveling in the right lane LR.

Therefore, when the vehicle 1 travels in the center lane LC, the control device 30 (for example, the steering control unit 32) sets, for example, the lane center line LCc of the center lane LC, which is the host lane, as the target traveling line Ltg. Accordingly, the vehicle 1 can travel along an appropriate target traveling line Ltg that matches the driver's sense of wanting to leave a certain distance from each of other lanes present on both sides in the left-right direction of the center lane LC that is the host lane.

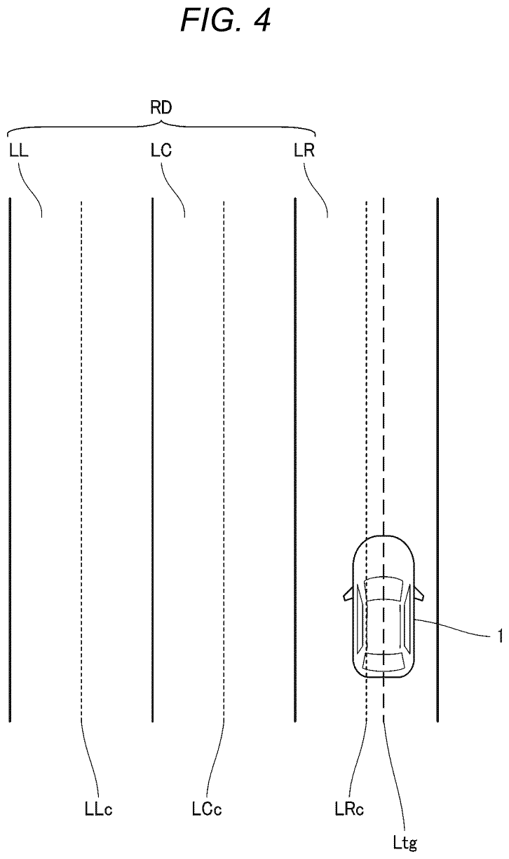

In the example illustrated in FIG. 4, the vehicle 1 travels in the right lane LR located at the rightmost side among the lanes of the road RD. In other words, in the example illustrated in FIG. 4, the right lane LR is the host lane in which the vehicle 1 travels. On the left side of the right lane LR that is the host lane, the center lane LC that is another lane is present. In such a case, the driver of the vehicle 1 traveling in the right lane LR often desires to drive the vehicle 1 at a certain distance from another vehicle traveling in the center lane LC.

Therefore, when the vehicle 1 travels in the right lane LR, the control device 30 (for example, the steering control unit 32) sets, as the target traveling line Ltg, a line offset to the right side by a predetermined offset amount from a lane center line LRc of the right lane LR that is the host lane, for example. Accordingly, the vehicle 1 can travel along an appropriate target traveling line Ltg that matches the driver's sense of wanting to leave a certain distance from the center lane LC present on the left side of the right lane LR that is the host lane.

As described above, when another lane is present on one side of the host lane in the left-right direction, the control device 30 (for example, the steering control unit 32) sets, as the target traveling line, a line offset to the other side in the left-right direction by a predetermined offset amount from the lane center line of the host lane, for example. Accordingly, the vehicle 1 can travel along an appropriate target traveling line that matches the driver's sense of wanting to leave a certain distance from another lane present on one side of the host lane in the left-right direction.

For example, when other lanes are present on both sides of the host lane in the left-right direction, the control device 30 (for example, the steering control unit 32) sets the lane center line of the host lane as the target traveling line. Accordingly, the vehicle 1 can travel along an appropriate target traveling line that matches the driver's sense of wanting to leave a certain distance from each of the other lanes present on both sides of the host lane in the left-right direction.

The control device 30 may vary the offset amount of the target traveling line between a case where an entry-allowing area is present adjacently to the host lane in which the vehicle 1 travels and a case where the entry-allowing area is not present.

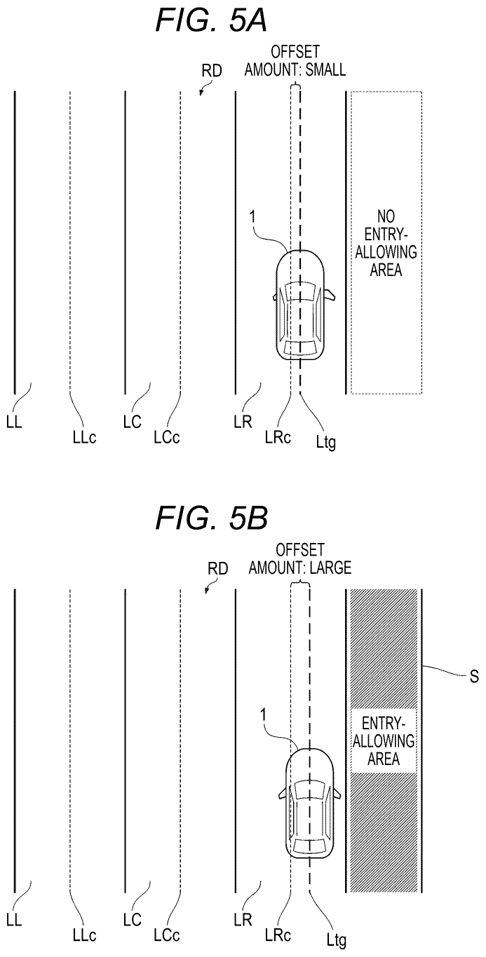

In the example illustrated in FIG. 5A, the vehicle 1 travels in the right lane LR located on the rightmost side among the lanes of the road RD. On the left side of the right lane LR that is the host lane, the center lane LC that is another lane is present. On the right side of the right lane LR that is the host lane, a guard rail or the like is provided, and an entry-allowing area S described later is not present.

On the other hand, in the example illustrated in FIG. 5B, the entry-allowing area S is present adjacently to the right lane LR on the right side, which is the host lane in which the vehicle 1 travels. As described, in the case where the vehicle 1 is traveling in the right lane LR and the entry-allowing area S is present adjacently to the right lane LR on the right side, the driver of the vehicle 1 often desires to drive the vehicle 1 along a line offset further to the right side from the lane center line LRc of the right lane LR, as compared with the case where the entry-allowing area S is not present as in the example illustrated in FIG. 5A.

Therefore, in the case where the vehicle 1 is traveling in the right lane LR and the entry-allowing area S is present adjacently to the right lane LR on the right side as in the example illustrated in FIG. 5B, the control device 30 may set, as the target traveling line Ltg, a line greatly offset as compared with the case where the entry-allowing area S is not present. Accordingly, the vehicle 1 can travel along an appropriate target traveling line Ltg that matches the driver's sense.

As described, in the case where another lane is present on one side of the host lane in the left-right direction and an entry-allowing area that the vehicle 1 is allowed to enter is present adjacently to the host lane on the other side of the host lane in the left-right direction, the control device 30 (for example, the steering control unit 32) may increase the offset amount of the target traveling line as compared with the case where the entry-allowing area is not present. In this way, the vehicle 1 can travel along an appropriate target traveling line that matches the driver's sense.

In the case where the other lane is present on one side of the host lane in the left-right direction and the entry-allowing area is not present adjacently to the host lane on the other side of the host lane in the left-right direction, the control device 30 may set the offset amount of the target traveling line to 0 (zero) and set the lane center line of the host lane as the target traveling line.

### Processing Executed by Control Device

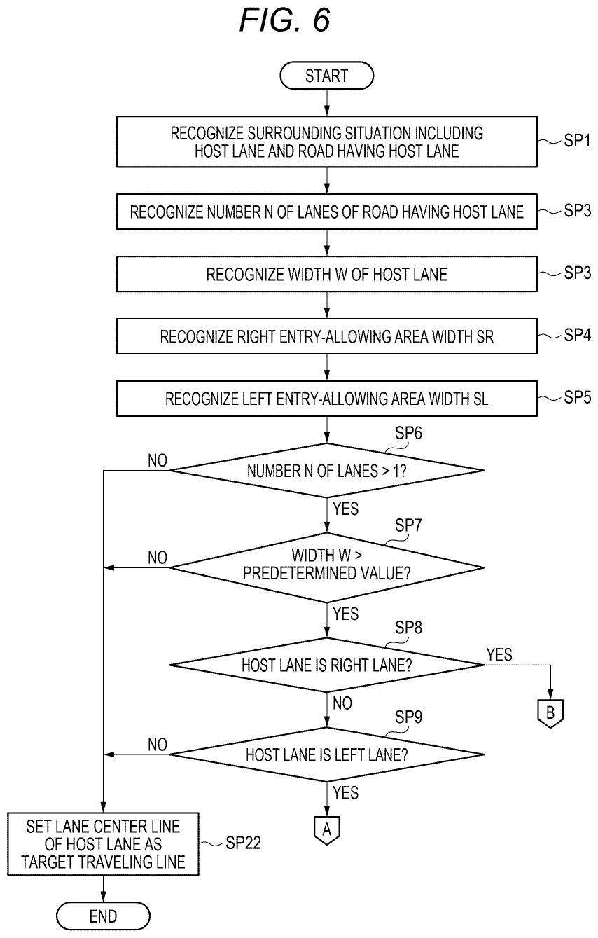

Next, an example of processing executed by the control device 30 will be described with reference to FIGS. 6 to 8. For example, when the steering control is being executed, the control device 30 repeatedly executes a series of processing illustrated in FIGS. 6 to 8 at a predetermined cycle.

As illustrated in FIG. 6, first, the control device 30 recognizes a surrounding situation of the vehicle 1 including a host lane and a road having the host lane (step SP1). Then, the control device 30 recognizes the number N of lanes of the road having the host lane based on a processing result of step SP1 (step SP2), and recognizes a width W of the host lane (step SP3). Further, based on the processing result of step SP1, the control device 30 recognizes a right entry-allowing area width SR of an entry-allowing area adjacent to the right side of the host lane (step SP4), and recognizes a left entry-allowing area width SL adjacent to the left side of the host lane (step SP5).

Next, the control device 30 determines whether the number N of lanes obtained by the processing of step SP2 is larger than “1” (step SP6). If it is determined that the number N of lanes is not larger than “1” (in other words, the number N of lanes is “1”) (step SP6: NO), the control device 30 sets a lane center line of the host lane as the target traveling line (step SP22), and ends the series of processing illustrated in FIGS. 6 to 8.

On the other hand, if it is determined that the number N of lanes is larger than “1” (step SP6: YES), the control device 30 determines whether the width W obtained by the processing of step SP3 is larger than a predetermined value (for example, 3.5 [m]) (step SP7). If it is determined that the width W is less than the predetermined value (step SP7: NO), the control device 30 proceeds to the processing of step SP22 described above, sets the lane center line of the host lane as the target traveling line, and ends the series of processing illustrated in FIGS. 6 to 8.

On the other hand, if it is determined that the width W is larger than the predetermined value (step SP7: YES), the control device 30 determines whether the host lane is a right lane located on the rightmost side among lanes of the road having the host lane (step SP8).

If it is determined that the host lane is not the right lane (step SP8: NO), the control device 30 determines whether the host lane is a left lane located on the leftmost side among lanes of the road having the host lane (step SP9). If it is determined that the host lane is not the left lane (step SP9: NO), the control device 30 proceeds to the processing of step SP22 described above, sets the lane center line of the host lane as the target traveling line, and ends the series of processing illustrated in FIGS. 6 to 8.

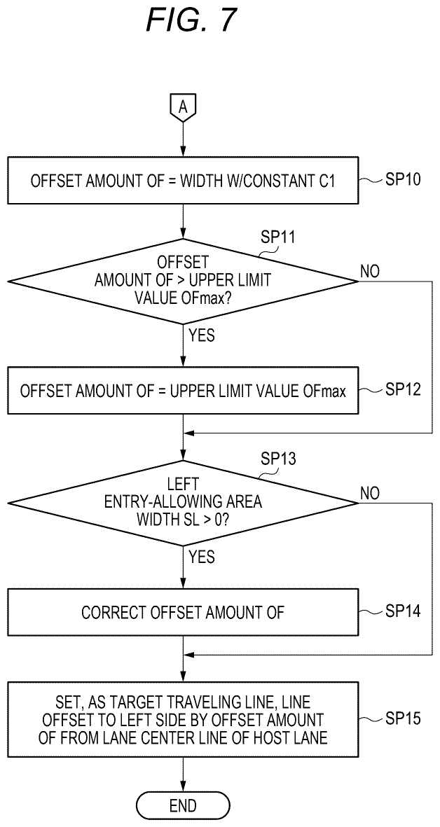

On the other hand, if it is determined that the host lane is the left lane (step SP9: YES), the control device 30 proceeds to the processing of step SP10 illustrated in FIG. 7, and sets a value obtained by dividing the width W by a predetermined constant C1 as an offset amount OF (step SP10). For example, when the constant C1 is set to “10”, in the processing of step SP10, a value equal to 1/10 of the width Wis set as the offset amount OF. The constant C1 is not limited to “10”, and for example, the manufacturer of the vehicle 1 can freely determine the constant C1.

Next, the control device 30 determines whether the offset amount OF set by the processing of step SP10 is larger than a predetermined upper limit value OFmax (step SP11). The upper limit value OFmax can be determined freely by the manufacturer of the vehicle 1, for example. If it is determined that the offset amount OF is equal to or less than the upper limit value OFmax (step SP11: NO), the control device 30 proceeds to the processing of step SP13.

On the other hand, if it is determined that the offset amount OF is larger than the upper limit value OFmax (step SP11: YES), the control device 30 sets the upper limit value OFmax as a new offset amount OF (step SP12).

Next, the control device 30 determines whether the left entry-allowing area width SL is larger than “0”, in other words, whether an entry-allowing area is present adjacently to the left side of the left lane that is the host lane (step SP13). If it is determined that the left entry-allowing area width SL is not larger than “0” (step SP13: NO), in other words, if it is determined that the entry-allowing area is not present adjacently to the left side of the left lane that is the host lane, the control device 30 proceeds to the processing of step SP15.

On the other hand, if it is determined that the left entry-allowing area width SL is larger than “0” (step SP13: YES), in other words, if it is determined that an entry-allowing area is present adjacently to the left side of the left lane that is the host lane, the control device 30 corrects the offset amount OF (step SP14).

In the processing of step SP14, for example, the control device 30 sets, as the new offset amount OF, a value obtained by adding a predetermined value (for example, 10 [cm]) to the offset amount OF set by the processing of step SP10. The predetermined value can be determined freely by the manufacturer of the vehicle 1, for example. The control device 30 may set the upper limit value OFmax as the new offset amount OF when the value obtained by adding the predetermined value to the offset amount OF set by the processing of step SP10 exceeds the upper limit value OFmax. When the upper limit value OFmax is set as the offset amount OF by the processing of step SP12, the control device 30 may proceed to the processing of step SP15 without performing the processing of step SP14.

Next, the control device 30 sets, as the target traveling line, a line offset to the left side by the set offset amount OF from the lane center line of the left lane that is the host lane (step SP15), and ends the series of processes illustrated in FIGS. 6 to 8.

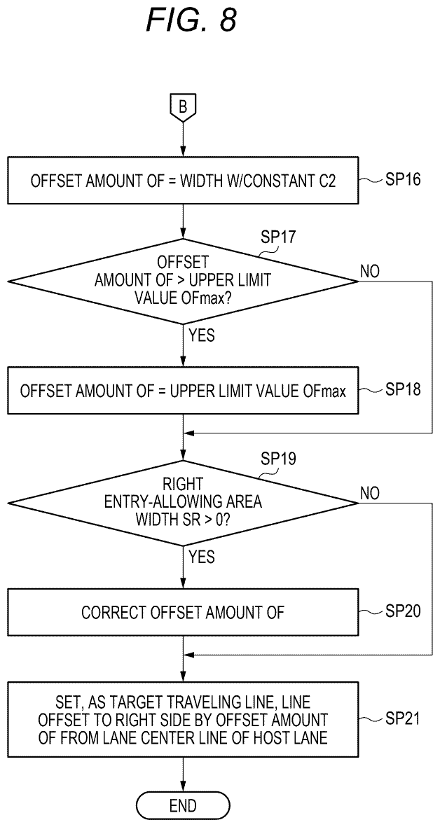

In the processing of step SP8 illustrated in FIG. 6, if it is determined that the host lane is the right lane (step SP8: YES), the control device 30 proceeds to the processing of step SP16 illustrated in FIG. 8, and sets a value obtained by dividing the width W by a predetermined constant C2 as the offset amount OF (step SP16). For example, the constant C2 can be freely determined by the manufacturer of the vehicle 1, similarly to the constant C1 described above.

Next, the control device 30 determines whether the offset amount OF set by the processing of step SP16 is larger than the predetermined upper limit value OFmax (step SP17). If it is determined that the offset amount OF is equal to or less than the upper limit value OFmax (step SP17: NO), the control device 30 proceeds to the processing of step SP19.

On the other hand, if it is determined that the offset amount OF is larger than the upper limit value OFmax (step SP17: YES), the control device 30 sets the upper limit value OFmax as the new offset amount OF (step SP18).

Next, the control device 30 determines whether the right entry-allowing area width SR is larger than “0”, in other words, whether an entry-allowing area is present adjacently to the right side of the right lane that is the host lane (step SP19). If it is determined that the right entry-allowing area width SR is not larger than “0” (step SP19: NO), in other words, if it is determined that the entry-allowing area is not present adjacently to the right side of the right lane that is the host lane, the control device 30 proceeds to the processing of step SP21.

On the other hand, if it is determined that the right entry-allowing area width SR is larger than “0” (step SP19: YES), in other words, if it is determined that an entry-allowing area is present adjacently to the right side of the right lane that is the host lane, the control device 30 corrects the offset amount OF (step SP20).

In the processing of step SP20, for example, the control device 30 sets, as the new offset amount OF, a value obtained by adding a predetermined value (for example, 10 [cm]) to the offset amount OF set by the processing of step SP16. The predetermined value can be determined freely by the manufacturer of the vehicle 1, for example. The control device 30 may set the upper limit value OFmax as the new offset amount OF when the value obtained by adding the predetermined value to the offset amount OF set by the processing of step SP16 exceeds the upper limit value OFmax. When the upper limit value OFmax is set as the offset amount OF by the processing of step SP18, the control device 30 may proceed to the processing of step SP21 without performing the processing of step SP20.

Next, the control device 30 sets, as the target traveling line, a line offset to the right side by the set offset amount OF from the lane center line of the right lane that is the host lane (step SP21), and ends the series of processes illustrated in FIGS. 6 to 8.

As described above, according to the control device 30, when the number of lanes of the road having the host lane is larger than “1” and the host lane is the left lane or the right lane, the vehicle 1 can travel along the target traveling line that is offset in advance, regardless of the presence or absence of a target in another lane (for example, another vehicle traveling in another lane). Accordingly, the vehicle 1 can travel with a certain distance from a target present in another lane, and the vehicle 1 can be prevented from wobbling in the left-right direction with respect to the lane center line of the host lane, as compared with a case where the target traveling line is offset from the lane center line only in a section where a target is present in the other lane. Accordingly, the vehicle 1 can travel along an appropriate target traveling line while being prevented from wobbling in the left-right direction with respect to the lane center line of the host lane.

When the width W of the host lane is less than a predetermined value, if the vehicle 1 travels along the target traveling line offset to the left side or right side from the lane center line of the host lane, the vehicle 1 is too close to a left end or right end of the host lane (in other words, the traveling lane boundary), and the driver of the vehicle 1 may feel uneasy.

Therefore, as described above, the control device 30 (for example, the steering control unit 32) may set, as the target traveling line, a line offset to the left side or right side from the lane center line of the host lane when the road having the host lane has another lane and the width W of the host lane is equal to or greater than the predetermined value. In other words, even when the road having the host lane has another lane, if the width W of the host lane is less than the predetermined value, the control device 30 may not offset the line, which is to be set as the target traveling line, to the left side or right side from the lane center line of the host lane. In this way, it is possible to prevent occurrence of a situation in which the vehicle 1 is too close to the left end or right end of the host lane and the driver feels uneasy.

Further, a case is considered in which the reliability of the surrounding situation recognized by the recognition unit 31 (for example, the relative position between the vehicle 1 and an object present around the vehicle 1) may not be sufficient due to several factors such as bad weather, a bad road surface condition, or a failure of the external sensor 11. From the viewpoint of ensuring the safety of the vehicle 1, it is not preferable to offset the target traveling line from the lane center line of the host lane when such control is unstable.

Therefore, when the road having the host lane has another lane and the reliability of the surrounding situation recognized by the recognition unit 31 is equal to or greater than a predetermined value, the control device 30 (for example, the steering control unit 32) may set, as the target traveling line, a line offset to the left side or right side by a predetermined offset amount from the lane center line of the host lane. In other words, when the reliability of the surrounding situation recognized by the recognition unit 31 is less than the predetermined value, even if the road having the host lane has another lane, the control device 30 may not offset the target traveling line from the lane center line of the host lane. Accordingly, it is possible to prevent a situation in which, when the control of the vehicle 1 is not stable, the target traveling line is offset from the lane center line of the host lane, causing a decrease in safety of the vehicle 1. In this case, for example, the control device 30 or the like may further include a processing unit that evaluates, according to a predetermined condition, the reliability of the surrounding situation recognized by the recognition unit 31 and transmits an evaluation result to the steering control unit 32.

In a section having a large curvature (that is, a curve), the driver of the vehicle 1 often desires to drive the vehicle 1 near the lane center line of the host lane. Therefore, in a case where the steering of the vehicle 1 is being controlled such that the vehicle 1 travels along the target traveling line offset to the left side or right side from the lane center line of the host lane, when the vehicle 1 approaches a section having a curvature equal to or greater than a predetermined value, the control device 30 (for example, the steering control unit 32) may set, as a new target traveling line, a line whose offset amount from the lane center line of the host lane is reduced (for example, the offset amount is set to “0”) than before approaching the section. In this way, the vehicle 1 can travel along an appropriate target traveling line that matches the driver's sense of wanting to drive near the lane center line of the host lane in a section having a large curvature. In this case, the curvature serving as a condition for reducing the offset amount can be determined freely by the manufacturer of the vehicle 1, for example. The curvature serving as a condition for reducing the offset amount may be appropriately set by the driver of the vehicle 1.

### Modification of Vehicle Control

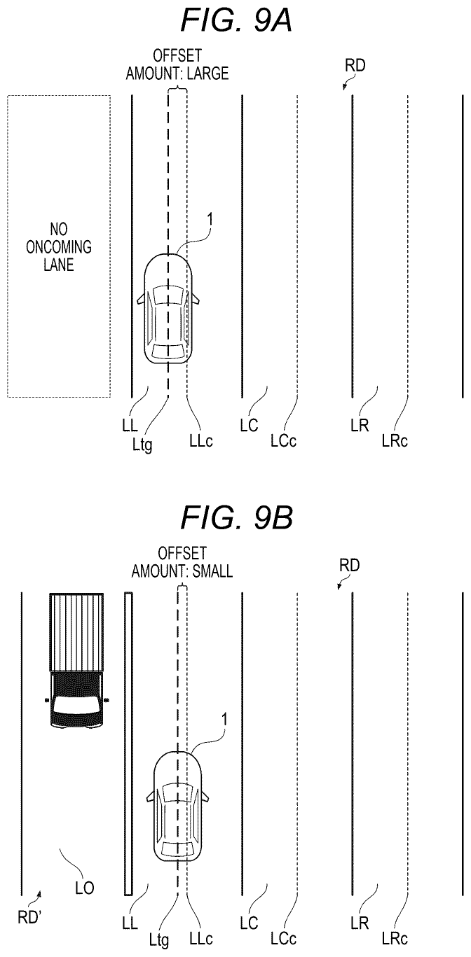

Next, a modification of the control of the vehicle 1 performed by the control device 30 will be described with reference to FIGS. 9A to 12.

The control device 30 may vary the offset amount of the target traveling line between a case where an oncoming lane is present adjacently to the host lane in which the vehicle 1 travels and a case where the oncoming lane is not present.

In the example illustrated in FIG. 9A, the vehicle 1 travels in the left lane LL located on the leftmost side among lanes of the road RD. On the right side of the left lane LL that is the host lane, the center lane LC that is another lane is present. On the left side of the left lane LL that is the host lane, an oncoming lane LO described later is not present.

On the other hand, in the example illustrated in FIG. 9B, a road RD′ different from the road RD is provided running side by side with the road RD, and the oncoming lane LO of the road RD′ is present on the left side of the left lane LL that is the host lane. Here, the oncoming lane LO is a lane in which the traveling direction is opposite to that in the lanes of the road RD having the left lane LL.

As described, in a case where another lane in which the traveling direction is the same as in the host lane is present on one side of the host lane in the left-right direction and an oncoming lane in which the traveling direction is opposite to that in the host lane is present on the other side of the host lane in the left-right direction, the control device 30 (for example, the steering control unit 32) may decrease the offset amount of the line, which is to be set as the target traveling line, as compared with a case where the oncoming lane is not present. More specifically, in the case of the example illustrated in (B) of FIG. 9, the control device 30 may set, as the target traveling line Ltg, a line whose offset amount to the left side from the lane center line LLc of the left lane LL is reduced as compared with the case of the example illustrated in (A) of FIG. 9.

That is, in the case where another lane in which the traveling direction is the same as in the host lane is present on one side of the host lane in the left-right direction and an oncoming lane in which the traveling direction is opposite to that in the host lane is present on the other side of the host lane in the left-right direction, the driver of the vehicle 1 may feel uneasy to approach the other side (that is, the oncoming lane side) of the host lane. Therefore, as described above, in the case where another lane in which the traveling direction is the same as in the host lane is present on one side of the host lane in the left-right direction and an oncoming lane in which the traveling direction is opposite to that in the host lane is present on the other side of the host lane in the left-right direction, the offset amount of the line to be set as the target traveling line is reduced, whereby the vehicle 1 can travel along an appropriate target traveling line that matches the driver's sense of wanting to leave a certain distance from the oncoming lane.

The control device 30 may vary the offset amount of the target traveling line between a case where the number of other vehicles traveling around the vehicle 1 is large and a case where the number of other vehicles traveling around the vehicle 1 is small.

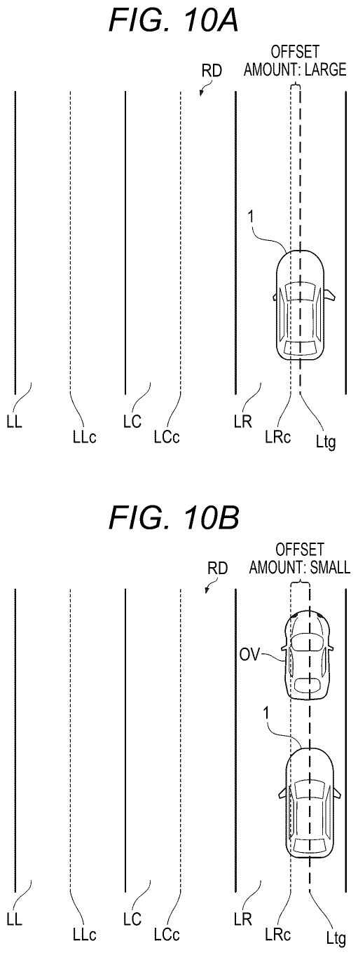

In the example illustrated in FIG. 10A, the vehicle 1 travels in the right lane LR located on the rightmost side among the lanes of the road RD. On the left side of the right lane LR that is the host lane, the center lane LC that is another lane is present. Another vehicle OV is present around the vehicle 1 (in the illustrated example, in front of the vehicle 1 in the right lane LR). On the other hand, in the example illustrated in FIG. 10B, no other vehicle OV is present around the vehicle 1 traveling in the right lane LR.

As described, when another lane is present on one side of the host lane in the left-right direction and the number of other vehicles traveling in the host lane is relatively small, the control device 30 (for example, the steering control unit 32) may reduce the offset amount of the line, which is to be set as the target traveling line, as compared with a case where the number of other vehicles is relatively large. More specifically, in the case of the example illustrated in FIG. 10B, the control device 30 may set, as the target traveling line Ltg, a line whose offset amount to the right side from the lane center line LRc of the right lane LR is reduced as compared with the case of the example illustrated in FIG. 10A. In this way, it is possible to prevent a situation in which the driver of the vehicle 1 is given a discomfort caused by the vehicle 1 traveling along a greatly offset target traveling line though the number of other vehicles present around the vehicle 1 is small.

In each example described above, if the host lane is a lane located on the left side of the center lane in a road, a line offset to the left side from the lane center line of the host lane is set as the target traveling line, and if the host lane is a lane located on the right side of the center lane, a line offset to the right side from the lane center line of the host lane is set as the target traveling line, and the disclosure is not limited thereto.

For example, the control device 30 may set the lane center line of the host lane as the target traveling line if the host lane is the right lane located on the rightmost side among the lanes of the road, and set, as the target traveling line, a line offset to the left side from the lane center line of the host lane if the host lane is a lane located on the left side of the right lane. Further, at this time, the control device 30 may vary the offset amount of the target traveling line between a case where two or more other lanes are present on the right side of the host lane and a case where one other lane is present on the right side of the host lane.

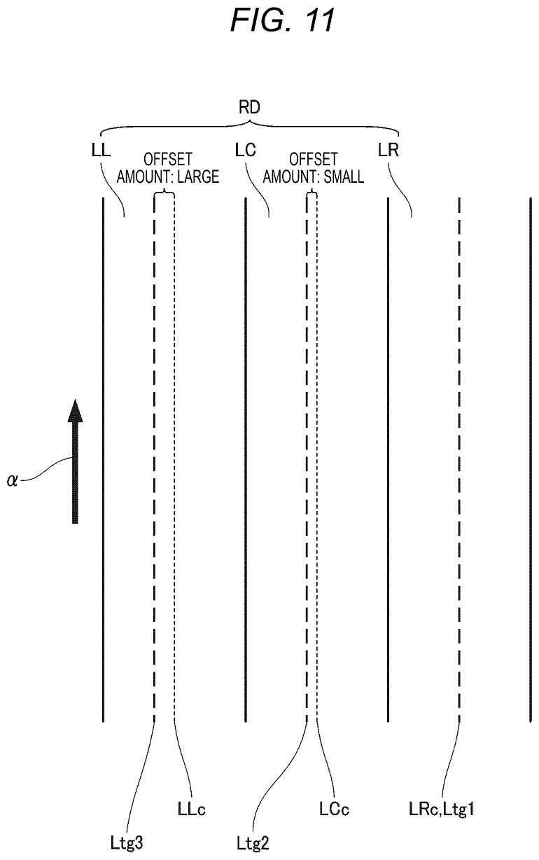

The road RD illustrated in FIG. 11 is a highway of which a direction indicated by an arrow a is the traveling direction, and is a three-lane road having the left lane LL, the center lane LC, and the right lane LR. For example, in the road RD illustrated in FIG. 11, a lane type of the right lane LR is a cruising lane, and lane types of the center lane LC and the left lane LL are overtaking lanes.

In the example illustrated in FIG. 11, when the vehicle 1 is traveling in the right lane LR (that is, the cruising lane), in other words, when the host lane is the right lane LR, the control device 30 may set the lane center line LRc of the right lane LR as a target traveling line Ltg1. When the vehicle 1 is traveling in the center lane LC (that is, the overtaking lane), in other words, when the host lane is the center lane LC, the control device 30 may set, as a target traveling line Ltg2, a line offset to the left side from the lane center line LCc of the center lane LC. When the vehicle 1 is traveling in the left lane LL (that is, the overtaking lane), in other words, when the host lane is the left lane LL, the control device 30 may set, as a target traveling line Ltg3, a line offset to the left side from the lane center line LLc of the left lane LL. In a case where the host lane is the left lane LL (in other words, in a case where two or more other lanes are present on the right side of the host lane), the control device 30 may increase the offset amount as compared with the case where the host lane is the center lane LC (in other words, the case where one other lane is present on the right side of the host lane).

In the example described here, the lane center line LRc of the right lane LR is set as the target traveling line Ltg1 if the host lane is the right lane LR, the line offset to the left side from the lane center line LCc of the center lane LC is set as the target traveling line Ltg2 if the host lane is the center lane LC, and the line greatly offset to the left side from the lane center line LLc of the left lane LL is set as the target traveling line Ltg3 if the host lane is the left lane LL, and the disclosure is not limited thereto.

For example, contrary to the above example, the lane center line LLc of the left lane LL may be set as the target traveling line if the host lane is the left lane LL, a line offset to the right side from the lane center line LCc of the center lane LC may be set as the target traveling line if the host lane is the center lane LC, and a line greatly offset to the right side from the lane center line LRc of the left lane LR may be set as the target traveling line if the host lane is the right lane LR.

As described above, in the case where two or more other lanes are present on one side of the host lane in the left-right direction, the control device 30 (for example, the steering control unit 32) may increase the offset amount of the target traveling line as compared with the case where one other lane is present on one side of the host lane in the left-right direction.

That is, in a case where two or more other lanes are present on one side of the host lane in the left-right direction, another vehicle traveling in another lane adjacent to the one side of the host lane may travel along a line offset to the other side in the left-right direction from the lane center line of the other lane. Therefore, in such a case, the driver of the vehicle 1 often desires to drive the vehicle 1 along a line offset further to the other side in the left-right direction from the lane center line of the host lane, as compared with the case where one other lane is present on one side of the host lane in the left-right direction.

Therefore, as described above, in the case where two or more other lanes are present on one side of the host lane in the left-right direction, a line offset further to the other side in the left-right direction from the lane center line of the host lane is set as the target traveling line as compared with the case where one other lane is present on one side of the host lane in the left-right direction, whereby the vehicle 1 can travel along an appropriate target traveling line that matches the driver's sense.

The control device 30 may determine, based on the lane type of the host lane, whether to offset the target traveling line. For example, when the lane type of the host lane is a cruising lane, the control device 30 may set the lane center line of the host lane as the target traveling line, and when the lane type of the host lane is an overtaking lane, the control device 30 may set, as the target traveling line, a line offset to the opposite side of a cruising lane from the lane center line of the host lane. Information indicating the lane type of lanes including the host lane can be acquired based on, for example, a recognition result for a road sign by the recognition unit 31, or the map information database 24.

Further, the techniques described with reference to FIGS. 2 to 4 and the technique described with reference to FIG. 11 may be adopted in combination.

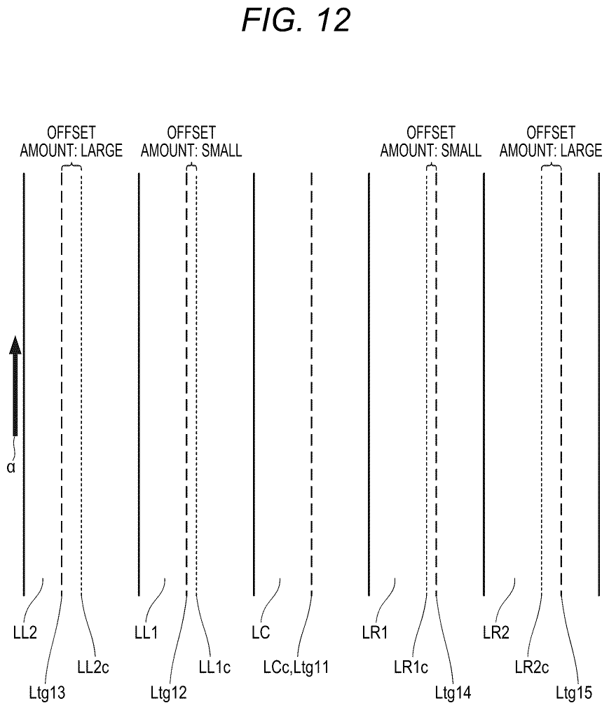

The road RD illustrated in FIG. 12 is a road of which a direction indicated by an arrow α is the traveling direction, and is a five-lane road having a left lane LL1, a right lane LR1, a leftmost lane LL2, a rightmost lane LR2, and the center lane LC. Here, the leftmost lane LL2 is a lane located on the leftmost side among the lanes of the road RD, and the rightmost lane LR2 is a lane located on the rightmost side among the lanes of the road RD. The left lane LL1 is a lane located between the leftmost lane LL2 and the center lane LC, and the right lane LR1 is a lane located between the rightmost lane LR2 and the center lane LC.

In the example illustrated in FIG. 12, when the vehicle 1 travels in the center lane LC, the control device 30 may set the lane center line LCc of the center lane LC as a target traveling line Ltg11. When the vehicle 1 travels in the left lane LL1, the control device 30 may set, as a target traveling line Ltg12, a line offset to the left side from a lane center line LL1c of the left lane LL1. When the vehicle 1 travels in the leftmost lane LL2, the control device 30 may set, as a target traveling line Ltg13, a line greatly offset to the left side from a lane center line LL2c of the leftmost lane LL2.

When the vehicle 1 travels in the right lane LR1, the control device 30 may set, as a target traveling line Ltg14, a line offset to the right side from a lane center line LR1c of the right lane LR1. When the vehicle 1 travels in the rightmost lane LR2, the control device 30 may set, as a target traveling line Ltg15, a line greatly offset to the right side from a lane center line LR2c of the rightmost lane LR2.

Although an embodiment of the present disclosure has been described above with reference to the drawings, it goes without saying that the present disclosure is not limited to the embodiment described above. It is apparent that those skilled in the art may conceive of various modifications and changes within the scope described in the claims, and it is understood that such modifications and changes naturally fall within the technical scope of the present disclosure.

In the present specification and the like, at least the following matters are described. Although corresponding constituent elements and the like in the embodiment described above are shown in parentheses, the present disclosure is not limited thereto.
(1) A vehicle control device (control device 30) for controlling a vehicle (vehicle 1), the vehicle control device including:
a recognition unit (recognition unit 31) that recognizes a surrounding situation of the vehicle including a host lane, in which the vehicle travels, and a road (road RD) having the host lane; and
a steering control unit (steering control unit 32) that sets a target traveling line (target traveling line Ltg, Ltg1 to Ltg3, Ltg11 to Ltg15) of the vehicle in the host lane based on the surrounding situation recognized by the recognition unit, and controls steering of the vehicle such that the vehicle travels along the target traveling line, in which
when the road has another lane adjacent to the host lane, the steering control unit is able to set, as the target traveling line, a line offset to a left side or a right side by a predetermined offset amount from a lane center line of the host lane.

According to (1), when the road having the host lane has another lane adjacent to the host lane, the host vehicle can travel along the target traveling line that is offset in advance, regardless of the presence or absence of a target in the other lane (for example, another vehicle traveling in the other lane). Accordingly, the host vehicle can travel with a certain distance from the target present in the other lane, and the host vehicle can be prevented from wobbling in a left-right direction with respect to the lane center line of the host lane, as compared with a case where the target traveling line is offset from the lane center line only in a section where a target is present in the other lane. Accordingly, the host vehicle can travel along an appropriate target traveling line while being prevented from wobbling in the left-right direction with respect to the lane center line of the host lane. In addition, it is possible to improve traffic safety and contribute to development of a sustainable transportation system.
(2) The vehicle control device according to (1), in which
when the other lane is present on one side of the host lane in a left-right direction, the steering control unit sets, as the target traveling line, a line offset to the other side in the left-right direction by the offset amount from the lane center line.

According to (2), the host vehicle can travel along an appropriate target traveling line that matches the driver's sense of wanting to leave a certain distance from another lane present on one side of the host lane in the left-right direction.
(3) The vehicle control device according to (2), in which
in a case where two or more other lanes are present on the one side of the host lane, the steering control unit increases the offset amount as compared with a case where one other lane is present on the one side of the host lane.

In the case where two or more other lanes are present on one side of the host lane in the left-right direction, another vehicle traveling in another lane adjacent to the one side of the host lane may travel along a line offset to the other side in the left-right direction from the lane center line of the other lane. Therefore, in such a case, the driver of the host vehicle often desires to drive the host vehicle along a line offset further to the other side in the left-right direction from the lane center line of the host lane, as compared with the case where one other lane is present on the one side of the host lane in the left-right direction. According to (3), the host vehicle can travel along an appropriate target traveling line that matches the driver's sense.
(4) The vehicle control device according to (2) or (3), in which
the other lane is a lane in which a traveling direction of a vehicle that travels is same as that in the host lane, and
in a case where the other lane is present on the one side of the host lane and an oncoming lane (oncoming lane LO) of the host lane is present on the other side of the host lane, the steering control unit reduces the offset amount as compared with a case where the oncoming lane is not present.

When another lane in which the traveling direction is the same as in the host lane is present on one side of the host lane in the left-right direction and an oncoming lane in which the traveling direction is opposite to that in the host lane is present on the other side of the host lane in the left-right direction, the driver of the host vehicle may feel uneasy to approach the other side (that is, the oncoming lane side) of the host lane. According to (4), the host vehicle can travel along an appropriate target traveling line that matches the driver's sense of wanting to leave a distance from the oncoming lane.
(5) The vehicle control device according to any one of (2) to (4), in which
in a case where the other lane is present on the one side of the host lane and an entry-allowing area (entry-allowing area S) that the vehicle is allowed to enter is present adjacently to the host lane on the other side of the host lane, the steering control unit increases the offset amount as compared with a case where the entry-allowing area is not present.

In the case where another lane is present on one side of the host lane in the left-right direction and the entry-allowing area is present adjacently to the host lane on the other side of the host lane in the left-right direction, the driver of the host vehicle often desires to drive along a line offset further from the lane center line of the host lane as compared with the case where the entry-allowing area is not present. According to (5), the host vehicle to travel along an appropriate target traveling line that matches the driver's sense.
(6) The vehicle control device according to any one of (2) to (5), in which
the recognition unit recognizes the surrounding situation further including another vehicle (another vehicle OV) present around the vehicle, and
in a case where the other lane is present on the one side of the host lane and the number of other vehicles traveling in the host lane is relatively small, the steering control unit reduces the offset amount as compared with a case where the number of other vehicles is relatively large.

According to (6), it is possible to prevent a situation in which the driver of the host vehicle is given a discomfort caused by the host vehicle traveling along a greatly offset target traveling line though the number of other vehicles present around host vehicle is small.
(7) The vehicle control device according to any one of (2) to (6), in which
when the other lane is present on both sides of the host lane in the left-right direction, the steering control unit is able to set the lane center line as the target traveling line.

According to (7), the host vehicle can travel along an appropriate target traveling line that matches the driver's sense of wanting to leave a certain distance from each of the other lanes present on both sides of the host lane in the left-right direction.
(8) The vehicle control device according to any one of (1) to (7), in which
when the road has the other lane and a width of the host lane is equal to or greater than a predetermined value, the steering control unit is able to set, as the target traveling line, a line offset to the left side or the right side from the lane center line.

According to (8), it is possible to prevent occurrence of a situation in which the host vehicle is too close to a left end or right end of the host lane and the driver feels uneasy.
(9) The vehicle control device according to any one of (1) to (8), in which
in a case where the steering of the vehicle is being controlled such that the vehicle travels along the target traveling line offset to the left side or the right side from the lane center line, when the vehicle approaches a section having a curvature equal to or greater than a predetermined value, the steering control unit is able to set, as a new target traveling line, a line whose offset amount is reduced than before approaching the section.

According to (9), the host vehicle can travel along an appropriate target traveling line that matches the driver's sense of wanting to drive near the lane center line of the host lane in a section having a large curvature.
(10) The vehicle control device according to any one of (1) to (9), in which
when the road has the other lane and reliability of the surrounding situation recognized by the recognition unit is equal to or greater than a predetermined value, the steering control unit is able to set, as the target traveling line, a line offset to the left side or the right side by the offset amount from the lane center line.

According to (10), it is possible to prevent a situation in which, when the control of the host vehicle is not stable, the target traveling line is offset from the lane center line of the host lane, causing a decrease in safety of the host vehicle.

1. A vehicle control device for controlling a vehicle, wherein the vehicle control device comprising circuitry configured to:
recognize a surrounding situation of the vehicle including a first lane, in which the vehicle travels, and a road having the first lane; and
set a target traveling line of the vehicle in the first lane based on the recognized surrounding situation, and control steering of the vehicle such that the vehicle travels along the target traveling line, wherein
when the road has a second lane adjacent to the first lane, the circuitry is configured to set, as the target traveling line, a line offset to a left side or a right side by a predetermined offset amount from a lane center line of the first lane.

2. The vehicle control device according to claim 1, wherein
when the second lane is present on one side of the first lane in a left-right direction, the circuitry sets, as the target traveling line, a line offset to the other side in the left-right direction by the offset amount from the lane center line.

3. The vehicle control device according to claim 2, wherein
in a case where two or more other lanes are present on the one side of the first lane, the circuitry increases the offset amount as compared with a case where one other lane is present on the one side of the first lane.

4. The vehicle control device according to claim 2, wherein
the second lane is a lane in which a traveling direction of a vehicle that travels is the same as that in the first lane, and
in a case where the second lane is present on the one side of the first lane and an oncoming lane of the first lane is present on the other side of the first lane, the circuitry reduces the offset amount as compared with a case where the oncoming lane is not present.

5. The vehicle control device according to claim 2, wherein
in a case where the other lane is present on the one side of the first lane and an entry-allowing area that the vehicle is allowed to enter is present adjacently to the first lane on the other side of the first lane, the circuitry increases the offset amount as compared with a case where the entry-allowing area is not present.

6. The vehicle control device according to claim 2, wherein
the circuitry recognizes the surrounding situation further including another vehicle present around the vehicle, and
in a case where the second lane is present on the one side of the first lane and the number of other vehicles traveling in the first lane is relatively small, the circuitry reduces the offset amount as compared with a case where the number of other vehicles is relatively large.

7. The vehicle control device according to claim 2, wherein
when the second lane is present on both sides of the first lane in the left-right direction, the circuitry is configured to set the lane center line as the target traveling line.

8. The vehicle control device according to claim 1, wherein
when the road has the second lane and a width of the first lane is equal to or greater than a predetermined value, the circuitry is configured to set, as the target traveling line, a line offset to the left side or the right side from the lane center line.

9. The vehicle control device according to claim 1, wherein
when the vehicle approaches a section having a curvature equal to or greater than a predetermined value while the steering of the vehicle is being controlled such that the vehicle travels along the target traveling line offset to the left side or the right side from the lane center line, the circuitry is configured to set, as a new target traveling line, a line whose offset amount is reduced than before approaching the section.

10. The vehicle control device according to claim 1, wherein
when the road has the second lane and reliability of the recognized surrounding situation is equal to or greater than a predetermined value, the circuitry is configured to set, as the target traveling line, a line offset to the left side or the right side by the offset amount from the lane center line.
